(19) United States
(12) Patent Application Publication
(10) Pub. No.: US 2006/0179162 A1
(43) Pub. Date: Aug. 10, 2006

(54) Responsive input units

(76) Inventor: Bartel Martinus Van De Sluis, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/523,471

(22) PCT Filed: Jul. 1, 2003
(86) PCT No.: PCT/IB03/03031

§ 371 Date: Dec. 22, 2005

(30) Foreign Application Priority Data
Aug. 7, 2002 (EP) 02078266.0

(51) Int. Cl. G06F 3/00

(52) U.S. Cl. 710/1

(57) ABSTRACT

The invention relates to a method and device for selecting an application to be displayed onto an output unit or screen, a computer program product and element for carrying out said method, as well as a method and device for determining the output device on which to display said application. A device for selecting an application to be displayed on at least one screen, contains one input unit that is associated with at least a first application unit, and another input unit that is associated with at least a second application unit in which an active input unit is identified, and the screen on which to display the associated application is determined upon identification by the input unit. The device enables an input unit to select an application to be displayed on a screen, which input unit is specially designed for the selected application.

### FIELD OF THE INVENTION

The present invention relates to the use of input units to select and control applications for networked output units, such as visual screens etc.

### BACKGROUND OF THE INVENTION

The number of screens, such as cathode ray tube screens, liquid crystal display screens, plasma screens, touch-sensitive screens, etc. has increased dramatically during recent years and the number is still expected to rise, especially since home electronics and personal goods, rising in numbers, tend to include screens or displays to illustrate, for example, the operation mode, settings and available options. Screens have become an important interface between man and machine.

This interface thus displays one or several applications on a screen. For the television screen, the main applications including watching television or video and playing games are currently relatively few. For the personal computer screen, however, a variety of tasks and activities can be supported. More and more screens have received an identity and an association to a network address, and hence have become part of a networked environment. Being networked screens become generic, i.e. they support numerous applications. The basic concept will be that ‘a screen is a screen’. The applications to be supported, apart from the watching television or video and playing games, as mentioned above, could for example be, using it as a whiteboard, sending and receiving E-mail messages, video-conferencing, browsing a photo collection, selecting music, to mention a few.

Each application to be displayed on a screen can be controlled by a so-called input unit. For the control of these applications one or two input units are typically used. For a television screen one input unit is mainly used, i.e. the remote control, whereas two input units, the mouse and the keyboard, are typically used to control a screen connected to a personal computer.

The applications or activities to be displayed on a screen accordingly outnumber the commonly used input units. For this reason, these input units have received a general function, i.e. they have become generic. For this reason each application will have to be selected from a menu structure that increases in complexity with the number of applications that can be selected from said structure. Going through menu structures, that have numerous submeans in a search for an application is tiresome and tends to prevent the user from finding the searched application, rather than directing him towards it. Already after a few steps of navigation in the menu structure, people become more reluctant to use the application. The usability of each such generic input unit will thus suffer from a lengthy and roundabout procedure to select as well as control the desired application.

There is thus a need for a method of enabling quick and easy access to and control of an application when an input unit is used to control a generic screen.

The state of the prior art in the field of computer peripherals is exemplified by document US 2002/0002490 which discloses a system for influencing a web consumer to keep a branded computer input unit that has a hard-wired or programmable switch that directs the web consumer to a specific web site that is operated by the sponsor of the computer input unit, thereby influencing the web consumer to continue to access the web site of the sponsor when the owner is seeking goods or services provided by the sponsor, and wherein the computer input unit can provide any combination of web navigation, computer input ports, enabling of e-commerce, telephone communication, and audio reproduction.

This input unit is capable of simplified web navigation by providing useful features such as scrolling, moving forwards and backwards and zooming. Said unit can further be personalized by programming buttons for direct access to selected web sites and by choosing personal images to be displayed on the input unit.

Hence an advantage of the computer input unit is that improved web navigation is provided.

A drawback of the input unit as explained above is that it is restricted to the use of directed web browsing.

Another drawback of said input unit is that it is restricted to the use of activities on specific web sites to be displayed on computer screens.

Yet another drawback is that said input unit is specially designed to control a single application, on a single screen without being equipped with intelligence to identify the input unit in action or to determine the application wanted or to decide on the screen, in case there are a number of input units, a number of applications and a variety of different screens.

It would thus be advantageous over prior art to provide a method of enabling an input unit to select and control an application to be displayed on an arbitrary screen.

It would also be advantageous over prior art to provide a method of enabling an input unit to select and control an application to be displayed on a selection of arbitrary screens.

It would further be advantageous over prior art to provide a method of enabling an input unit to select and control an application to be displayed on a screen, which input unit is especially suited for applications of the same type as the selected application.

In addition it would be advantageous over prior art to provide a method of enabling an input unit to circumvent the process of searching through lengthy and complex menu structures to select and control a desired application.

It would furthermore also be advantageous over prior art to provide a method of enabling an input unit to select an application to be displayed on an arbitrary screen, which screen is decided on in dependence on the strength of a signal that is transmitted by the input unit.

### SUMMARY OF THE INVENTION

It is an object of the invention to provide a device in which an input unit can easily select and control a whole application without the need for the user to navigate through lengthy and complex menu structures.

It is also an object of the invention to simplify the selection of applications when several applications and input units are present.

This object is achieved by a first aspect of the present invention, where a device is provided for selecting an application comprising at least a first application unit, at least a second application unit, at least one output unit, a first input unit being associated with at least a first application unit, a second input unit being associated with at least a second application unit, and a control unit arranged to identify an active input unit and to present the associated application on the output unit upon the identification of an active input unit.

This object is also achieved by a second aspect of the present invention where a method is provided of selecting an application to be presented on at least one output unit, a first input unit being associated with at least a first application and a second input unit being associated with at least a second application, including identifying an active input unit and resenting the associated application on the output unit upon the identification of the active input unit.

It is another object of the invention to provide a system with which an input unit can select and control an application to be displayed on an arbitrary screen.

It is yet another object of the invention to provide a system with which an input unit can select and control an application to be displayed on an arbitrary screen, which screen is determined by the closeness between said screen and said input unit.

These objects are achieved by a third aspect of said invention, where a device is provided, comprising the features according to the device of the first aspect, as well as at least a first output unit, at least a second output unit, at least two interface units each being related to a different output unit, arranged to measure a signal strength of a signal coming from the input unit, and where the control unit is further arranged to select an output unit in dependence on the measurement.

These objects are furthermore achieved by a fourth aspect of the present invention, where a method is provided comprising the steps of the method according to the second aspect, the step of determining the output unit from at least two output units on which to present the associated application, as well as the steps of measuring the strength of a signal coming from the input unit at at least two interface units, each related to a different output unit, and selecting an output unit in dependence on the measurement.

In accordance with a fifth aspect of the present invention a device is provided comprising the features according to the device of the first aspect, as well as at least one motion sensor arranged to sense a movement of an input unit.

In accordance with a sixth aspect of the present invention a method is provided comprising the steps of the method according to the second aspect, as well as the step of sensing a movement of the input unit.

In accordance with a seventh aspect of the present invention a device is provided comprising the features of the device according to the third aspect, as well as a signal strength determination unit, arranged to determine the highest signal strength measured by the interface units.

In accordance with an eighth aspect of the present invention a method is provided comprising the steps of the method according to the fourth aspect, as well as the steps of selecting the output unit for which the corresponding interface unit has measured the highest signal strength.

Thus a device and a method according to the present invention have been described having the following advantages.

The method and device according to the present invention for selecting an application to be presented on an output unit has the advantage over the prior art in that it enables quick and easy access to the application, since the input unit is associated with an application unit of the chosen application, and control of the application, since the input unit is specially designed for applications of the same type as said associated application, when the input unit is used to present or display the association on a generic screen.

Another advantage of the device according to the present invention is that it enables an input unit to select an application to be displayed on a screen, which input unit is specially designed for the selected application.

Yet another advantage of the device according to the present invention is that it circumvents the process of searching through lengthy and complex menu structures when the desired associated application to be displayed on an output unit is selected.

Still yet another advantage of the present invention is that it enables an input unit to select an application to be displayed on a screen, which screen is determined by the strength of a signal that is transmitted by the active input unit.

In relation to certain aspects of the present invention, the method and device according to the invention also has the following advantages:

it enables an input unit to select an application to be displayed on an arbitrary screen,

it can also comprise a selection of arbitrary screens on which the selected applications can be displayed,

it further enables an input unit to select an application by using wireless contact between said input unit and at least one interface unit.

These and other objects, features, advantages and alternative aspects to the present invention will become apparent to those skilled in the art from a consideration of the following detailed description taken in combination with the accompanying drawings.

### BRIEF DESCRIPTION OF THE DRAWINGS

FIG. 1 shows a device for selecting an application to be displayed on a screen.

FIG. 2 depicts a flowchart of a method of selecting an application to be presented on an output unit.

FIG. 3 schematically depicts a device for determining on which output unit to resent the associated application.

FIG. 4 presents a flowchart of a method of selecting the output unit on which he application is to be presented.

FIG. 5 illustrates a compact disc as an example of a computer readable medium.

### DETAILED DESCRIPTION OF THE INVENTION

Reference will now be made to the drawing figures in which various elements of the present invention will be given in numerical designations and in which the invention will be discussed so as to enable one skilled in the art to make and use the invention. It is to be understood that the following description is only exemplary of the principles of the present invention and should not be viewed as narrowing the claims that follow.

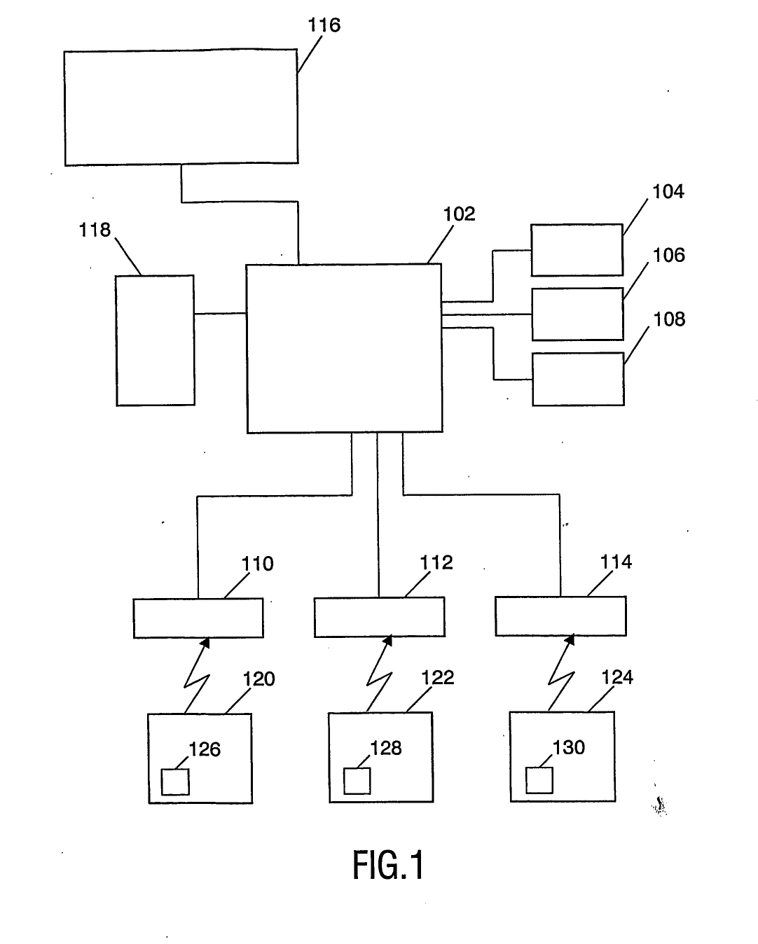

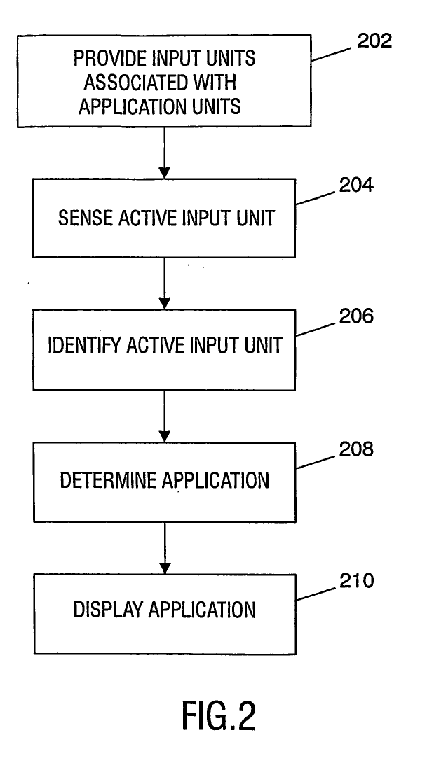

A first and a second aspect of the present invention will now be explained with reference to FIG. 1, showing a device for selecting an application to be displayed on a screen, and to FIG. 2, depicting a flowchart of a method of selecting an application to be presented on an output unit.

A device to select an application to be presented on an output unit is illustrated in FIG. 1. To produce a method of selecting one application from many applications to be presented on a screen upon action by an input unit that is specially designed to control applications of the same type as the selected application, requires intelligence for a number of reasons. Firstly, to identify which input unit is in action. Secondly, to determine which output unit to launch the chosen application on and thirdly, to determine which application to be launched on said output unit. For these purposes, this device for selecting an application is equipped with a control unit 102 which is further connected to a screen 116 functioning as an output unit, to enable presentation of the chosen application on said screen 116. To enable selection of an application in dependence on which input unit 120,122,124 is in action, three input units each containing a motion sensor 126,128,130 are in wireless radio contact with the control unit 102 via a respective interface unit 110,112,114. In addition, the control unit 102 is connected to three application units 104,106,108 where each application unit is application-specific and each application can be contained in one application unit only, in order to realize the selection of the associated application. There is thus one interface unit 110,112,114 per input unit 120,122,124.

There are more interface units and output units than is disclosed and described here. However, they will be further described in relation to a third aspect of this embodiment.

The information about which application to present on the output unit upon an action by a certain input unit 120,122,124 i.e. the associations between the input units 120,122,124 and the specific application units 104,106,108 is stored in a database 118 that is connected to the control unit 102.

As illustrated in FIG. 2, according to a preferred embodiment of a method of selecting an application to be displayed on a screen 116 starts by providing at least two input units 120,122,124 where a first input unit 120 is associated with at least a first application unit 104 and a second input unit 122 is associated with at least a second application unit 106, step 202. Subsequently, the step of sensing an active input unit, step 204, comprises sensing a movement by an input unit 120,122,124 transmitting a radio signal from the input unit 120,122,124 to the corresponding interface unit 110,112,114 and receiving the radio signal transmitted from the input unit 120,122,124 in the control unit 102 via the respective interface unit 110,112,114. Thereafter, the control unit identifies the active input unit 120,122,124, step 206, and determines the application of the application unit 104,106,108 that is associated with said active input unit 120,122,124, step 208. The control unit 103 then orders said application to be launched on the output unit 116, step 210.

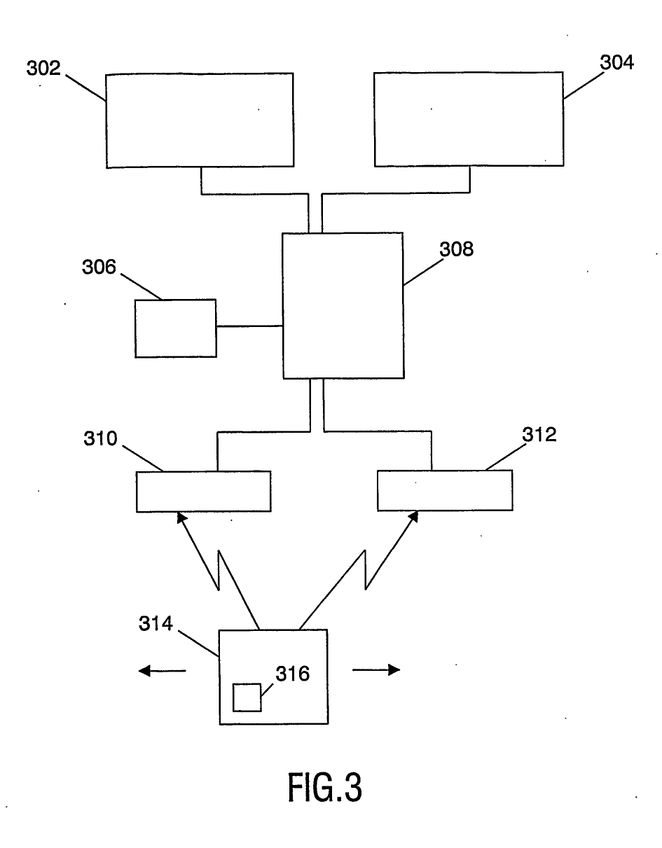

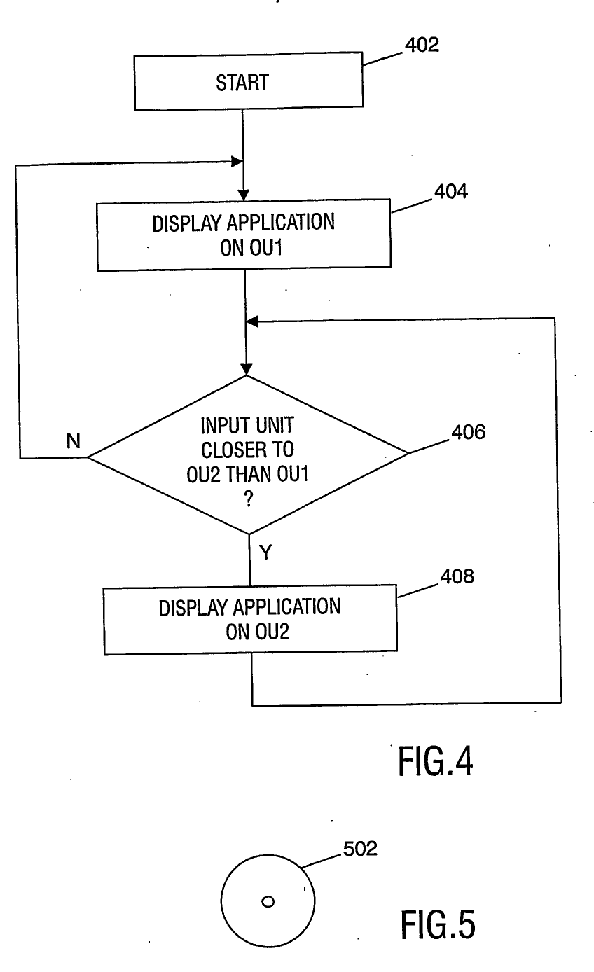

A third and fourth aspect of the present invention will now be explained with reference to FIG. 3, schematically depicting a device for determining on which output unit to present an associated application, and to FIG. 4, presenting a flowchart of a method of selecting which output device to launch the application on.

According to the present invention there may thus be several output units on which applications can be presented.

In FIG. 3 is illustrated a device to determine, for one input unit, the output unit on which one associated application is presented. According to this embodiment, said device comprises at least two output units in the form of two screens 302, 304 connected to a control unit 308, which is further connected to at least two interface units 310,312, each corresponding to a different output unit or screen 302,304, and a signal strength determination unit 306. The input unit 314, equipped with motion sensor 316, is in wireless radio contact with the interface units 310,312.

The device according to the third aspect of the present invention as illustrated in FIG. 3 preferably contains several input units, several application units, and a database, like the device according to the first aspect of the present invention as shown in FIG. 1. For clarity these additional units have been omitted in FIG. 3 to draw the reader's attention to the central idea behind said third aspect of the present invention.

The method according to the fourth aspect of the present invention includes a determination of which output unit in the form of a screen 302,304 to launch an application on. This determination is based on the proximity of an active input unit 314 to the interface units 310,312 each corresponding to a different screen 302,304 and each preferably in the vicinity of the respective screen 302,304.

This method of determination starts, step 402, by displaying an application on a first screen 302, step 404. Upon movement of the active input unit 314 the interface units 310,312 that include measurement units receive a radio signal and measure the strength of said radio signal that is transmitted by the moving input unit 314. This signal strength information is then forwarded to the control unit 102,308 which orders the signal strength determination unit 306 to compare the different signal strengths and determine which signal strength is the highest. After this determination by the signal strength determination unit 306 information about which measured signal has the highest strength is forwarded to the control unit 308. Said control unit 308 then determines which interface unit 310,312 has measured this highest signal strength and selects the output unit 302,304 that corresponds to said interface unit 310,312, on which the application is presented.

On the whole the control unit 308 determines whether the active input unit 314 is closer to the interface unit 310,312 corresponding to the second screen or output unit OU2, 304 than the interface unit corresponding to the first screen or output unit OU1, 302.

Again on the whole, if the input unit is closer to the second screen 304, e.g. if the question is answered affirmatively, Y, the displaying of the associated application is changed from the first screen or OU1, 302 to the second screen or OU2, 304, whereupon the application will be resumed on said second screen or OU2, 304. If said question is answered negatively, N, i.e. if said input unit 314, is not closer to the second screen or OU2, 304 than the first screen or OU1, 302, the displaying of the associated application is continued on the first screen or OU1, 302.

More precisely, the control unit 308 decides to display the application on the screen, or output unit 302,304, for which the corresponding interface unit 310,312 has measured the strongest radio signal. The control unit 308 thus selects the output unit or screen 302,304 in dependence on the result of the measurements.

Upon every movement of the active input unit 314 the strength of the radio signal transmitted from said active input unit 314 is measured and in dependence to the result of this measurement an output unit or screen 302,304 is selected to display an associated application.

After ending or pausing the display of an associated application on an output unit or screen 302,304 the application is resumed on the output unit 302,304 upon activation of the input unit 314 if the interface unit 310,312 corresponding to the output unit 302,304 has measured the strongest radio signal.

In addition, FIG. 5 illustrates a compact disc 502 as an example of a computer readable medium, being a computer program, having thereon a computer program code to make a computer perform the method according to the invention when said computer program is loaded in the computer which is included in the device according to the invention.

This invention can be varied in many ways, for instance:

In another embodiment of the present invention the method presents a selection of applications, each associated with the input unit, upon action by said input unit.

In another embodiment of the present invention the device for selecting an application to be presented on an output unit comprises at least two interconnected control units.

In another embodiment of the present invention the method resumes the presentation of a selection of possible applications upon movement of the active input unit.

In another embodiment of the present invention the device for determining the output unit on which to present the application comprises more than one input unit.

In still another embodiment of the present invention the step of determining the output unit on which to present an application includes measuring the strength of a signal coming from at least two interface units each related to a different output unit at at least one input unit, and selecting an output unit in dependence on the measurement.

In still another embodiment of the present invention the step of determining an output unit on which to present an application includes determining the physical position within perception limits of at least one output unit, of an active input unit in relation to at least two interface units, each related to a different output unit and selecting an output unit in dependence on the determined position. In this case a positioning signal is either sent from an interface unit or from the active input unit.

In still another embodiment of the invention the step of identifying the active input unit includes sensing a signal coming from the input unit upon pressing a button or a key on said input unit.

In a different embodiment of the invention the step of identifying the active input unit includes sensing a signal coming from the input unit upon activating a touch control or touch-sensitive region positioned on said input unit.

In a different embodiment of the invention the step of identifying the active input unit includes sensing a signal coming from the input unit upon activating a heat-sensitive sensor positioned in said input device.

In a different embodiment of the present invention, the step of identifying the active input unit includes sensing a directional infra-red (IR) signal coming from the input unit.

In a different embodiment of the present invention the step of identifying the active input unit includes sensing a diffuse infra-red (IR) signal coming from the input unit.

In yet a different embodiment of the present invention the step of identifying the active input unit includes sensing a microwave signal coming from the input unit.

In yet a different embodiment of the present invention at least two applications are selected to be displayed on the same output unit.

In still yet another embodiment of the present invention one or more applications are selected to be displayed on at least two output units.

In still yet another embodiment of the present invention output units can be produced by acoustic transmitters i.e. loudspeakers.

In still yet another embodiment of the present invention a selection of at least one application is presented on one type of output unit, for instance a screen, whereas the application, upon selection, is launched on a second type of output unit for instance, a loudspeaker system.

In still yet another embodiment of the present invention a selection of at least one application is presented by one type of output unit e.g. a loudspeaker system, and the application is launched on the same type of output unit upon selection of said application by applying voice control.

There has thus been described a device and a method according to the present invention with the following advantages.

The method of selecting an application to be presented on an output unit has the advantage over the prior art in that it enables a quick and easy access to the application, since the input unit is associated with an application unit of the chosen application and control of the application, since the input unit is specially designed for applications of the same type as said associated application, when the input unit is used to present or display the association on a multifunctional, i.e. generic, screen.

The method according to the present invention also has the following advantages:

it enables an input unit to select an application to be displayed on an arbitrary screen,

it can also comprise a selection of arbitrary screens, on which the selected applications can be displayed,

it further enables an input unit to select an application by using a wireless contact between said input unit and at least one interface unit.

Another advantage of the device according to the present invention, is that it enables an input unit to select an application to be displayed on a screen, which input unit is specially designed for the selected application.

Yet another advantage of the device according to the present invention is that it circumvents the process of searching through lengthy menu structures when the desired associated application to be displayed on an output unit is selected.

Still another advantage of the present invention is that it enables an input unit to select an application to be displayed on an screen, which screen is determined by the strength of a radio signal that is transmitted by the active input unit.

1. Method of selecting an application to be presented on a least one output unit, where a first input unit is associated with at least a first application and a second input unit is associated with at least a second application, including
identifying an active input unit, and
presenting the associated application on the output unit, upon the identification of the active input unit.

2. Method according to claim 1, in which the step of identifying the active input unit, includes
sensing a movement of the input unit.

3. Method according to claim 1, including
determining the output unit, from at least two output units on which to present the associated application.

4. Method according to claim 3, in which the step of determining the output unit includes
measuring the strength of a signal, coming from the input unit at at least two interface units, each related to a different output unit, and
selecting an output unit in dependence on the measurement.

5. Method according to claim 4, including
selecting the output unit for which the corresponding interface unit has measured the highest signal strength.

6. Method according to claim 1, including
controlling the selected application by the active input unit that is specially designed for applications of the same type as the associated application.

7. Method according to claim 1, including
starting the associated application if said associated application is singular.

8. Method according to claim 1, in which the associated application is displayed on a visual screen.

9. Method according to claim 8, in which the visual screen is a television screen.

10. Method according to claim 1, in which the associated application is the application that was presented when the input unit was used last.

11. Method according to claim 1, in which the presenting of the application includes resuming the application subsequent to ending or pausing said application.

12. Method according to claim 1, including
associating at least one active input unit with at least a first and a second application after the use of said at least one active input unit.

13. Device for selection of an application comprising,
at least a first application unit,
at least a second application unit,
at least one output unit,
a first input unit associated with at least a first application unit,
a second input unit associated with at least a second application unit, and
a control unit, arranged to identify an active input unit and present the associated application on the output unit upon the identification of an active input unit.

14. Device according to claim 13, comprising,
at least one motion sensor arranged to sense a movement of an input unit.

15. Device according to claim 13, comprising
at least a first output unit,
at least a second output unit,
at least two signal measurement units, each being related to a different output unit arranged to measure a signal strength of a signal coming from the input unit, and
where the control unit is further arranged to select an output unit in dependence on the measurement.

16. Device according to claim 15, comprising a signal strength determination unit arranged to determine the highest signal strength measured by the signal measurement units.

17. Computer program product comprising a computer readable medium, having thereon,
a computer program code to make a computer execute a procedure, when said program is loaded in the computer,
to select an application to be presented on at least one output unit, where a first input unit is associated with at least a first application unit and a second input unit is associated with at least a second application unit,
to identify an active input unit, and
to order presentation of the associated application on the output unit, upon the identification of the active input unit.

18. Computer program element comprising,
a computer program code to make a computer execute a procedure,
to select an application to be presented on a least one output unit, where a first input unit is associated with at least a first application unit and a second input unit is associated with at least a second application unit,
to identify an active input unit, and
to order presentation of the associated application on the output unit, upon the identification of the active input unit.
